(19) United States
(12) Patent Application Publication
(10) Pub. No.: US 2022/0108330 A1
(43) Pub. Date: Apr. 7, 2022

(54) INTERACTIVE AND ITERATIVE BEHAVIORAL MODEL, SYSTEM, AND METHOD FOR DETECTING FRAUD, WASTE, ABUSE AND ANOMALY

(71) Applicant: Rebecca Mendoza Saltiel, Oak Brook, IL (US)

(72) Inventor: Rebecca Mendoza Saltiel, Oak Brook, IL (US)

(21) Appl. No.: 17/064,368

(22) Filed: Oct. 6, 2020

(51) Int. Cl. G06Q 30/00; G06N 3/08

(52) U.S. Cl. CPC G06Q 30/0185; G06N 3/08

(57) ABSTRACT

An interactive and iterative system is useful for investigating fraud, waste, abuse and anomaly (FWAA). It is based on a FWAA model that applies to many different types of FWAA. The system includes a data inputs classifier based on the model, a plurality of databases based on the model for containing the classified data inputs, programming to identify missing data, and a classifier programmed to generate an analytic roadmap of the investigation case to aid in the investigation and programmed to identify abnormal data points in the pooled database.

### FIELD OF THE INVENTION

The present invention relates to a computer-based tool for investigations of cases of fraud, waste, abuse and anomaly (FWAA).

### BACKGROUND

Abnormalities that result in fraud, waste and abuse are pervasive in the healthcare industry because ethically challenged individuals, groups and/or corporations abuse the system and then use deceptive tactics, techniques and procedures to avoid detection. Improper investigations result in the inability to draw a conclusion or end with a false result because of known or unknown information gaps. Investigation is compromised because the basic building blocks of deception manifest themselves as moving targets, compromising the ability to expose deceptive measures. The ability to pinpoint subterfuge is compromised by a significant lack of subject matter expertise; ineffective use and/or development of new and emerging algorithmic protocols; limited historical attributes; adversary knowledge of audit methods and tools and avoidance of areas under scope and review (the investigative metric is $1M steal/embezzled $0.9M); a lack of internal controls within dynamic business environments; a lack of inventory management controls, creating a “needle in a haystack” environment; tools that use estimates versus targeting specific elements of fraud, waste and abuse; and predictive modeling versus extracting current active data points. Industry literature is rampant with instances of transaction errors, waste and criminal fraud. Illustrative examples: Medicare paid $25 million to deceased persons and $29 million in drug benefits for illegal immigrants from 2009 to 2011. A US government contract initiative pursued the development of a “fraud prevention system” that was established in 2011 as a predictive modeling program. This program provided limited results of $115 million dollars in Medicare claims that were either “stopped, prevented, or identified,” resulting in a 0.01% impact on the estimated 19% of Medicare spending that is lost due to fraud, waste and abuse. In essence, at least eighteen percent of Medicare spending is still lost to fraud, waste and abuse that circumvents existing controls and initiatives. The Association of Certified Fraud Examiners' “2014 Report to the Nation” reveals that occupational fraud may account for 5% of annual corporate revenues. Based on the 2013 estimated Gross World Product of $73.87 trillion, this projects a potential total global fraud loss of $3.7 trillion alone in this category of fraud, Counterfeiting, another category of fraud, is another pervasive issue. It does not appear that any industry is immune from counterfeit threat. An illustrative example of the scope of this niche fraudulent area can be found in a report by the International Anti-Counterfeiting Coalition. They report for the fiscal year 2013 that the Department of Homeland Security seized an estimated $1.7 billion in counterfeit goods at U.S. borders.

Government and private sector entities have deployed various initiatives and programs in order to attempt to combat fraud, waste and abuse. These initiatives are limited by their data analytic techniques and/or methods that are functionally disconnected and unorganized, lacking a holistic approach. Failure by government and private sector entities in the detection, mitigation and prevention of fraud, waste and abuse results from the use of tools that are narrowly focused on a limited range of data points, as opposed to incorporating varying levels of data that are situationally relevant. Today's standard approach involves using tools that are algorithm based. This type of strictly data-driven, algorithmic approach creates limitations due to its use as a linear, narrow, and/or exclusively analytically-driven tool that utilizes only fragments of data. Ethically challenged individuals prey on this use of fragmented data, using knowledge of fraud detection methods to give themselves the space to attack. This occurs because the user of the tools is starting off by using only a defined algorithm, meaning that they only gather certain points of information, narrowing down their input without first gathering an understanding of all of the existing data. As a result, current analytic methods fail to incorporate key metric components, including behavioral understanding, identification of all relevant fragmented data elements, and the collection, authentication, processing, and transformation of data elements using behavioral understanding. A holistic, all-inclusive finding is not possible without these key elements, Fragmented analysis and the use of limited algorithmic tools result in the misinterpretation of results and the failure to identify the etiology of fraud, waste and abuse. Fragmented or non-holistic analytic tools result in failure to detect, identify and define “real-time” data points that contribute to or completely mask the indications and warnings of: fraud, unacceptable risk, noncompliance, Activities of Daily Living flows (ADL's), Activities of Daily Work flows (ADW's) and corresponding Prevention, Detection and Mitigation work flows (PDM's). Fraud within traditional brick and mortar environments, coupled with criminal cyber enterprise activity, continues to flourish worldwide and remains embed within environments that lack systematic controls. Current market place tools that apply retrospective, prospective, and concurrent analytic fraud detection and prevention programs are hampered by technical limitations which narrow their scope and effectiveness at detecting fraud, waste and abuse.

A need therefore exists for a system and method that provides an analytical roadmap and a mechanism to mitigate inadequate, disconnected, un-unified, fragmented information while addressing personal bias and professional, political, psychosocial and socioeconomic conditions, allowing for a holistic “head-to-toe” approach to combating fraud, waste and abuse. The needed system and method should provide the assurance of appropriate data point capture, resulting in a highly stable fraud, waste, abuse and anomaly detection tool. The execution, unification and combination of identified behavioral components should result in a mature outcome determination. A system and method is needed to bridge the method and tool gap currently encountered while employing existing systems, moving above and beyond the capabilities of current standards. A system is also needed that would allow a user to provide data input in a linear and non-sequential order.

### SUMMARY OF THE INVENTION

In one embodiment of the invention, a system using artificial intelligence for investigating cases of fraud, waste, abuse and anomaly is provided. The system has a server configured to receive data inputs for an investigation case of fraud, waste or abuse and a data inputs classifier for classifying the data inputs into a plurality of data categories of a framework of a fraud, waste or abuse model. The system also has a plurality of databases corresponding to the data categories of the framework and the server is programmed to sort the classified data inputs into the databases by data category and into a pooled database of the case. The databases may contain data inputs from prior investigation cases. The server is programmed to identify discoverable gaps in the pooled database of the case.

The data inputs classifier may have artificial intelligence selected from the group consisting of a decision tree, a neural network, an expert system and combinations thereof. The data inputs classified may have all three items in the group.

The data categories may include at least one category selected from the group consisting of a players category, a benchmarks category, a functional information category, a rules-based category, a transparency category, and a consequence category. In a preferred embodiment, the data categories include at least two categories from the group and preferably the player category. More preferably the data categories include at least three, four, five or all six categories in the group.

The system may also have a data warehouse encompassing the databases. The data warehouse has a fact table containing reference keys pointing to dimension tables in each of the databases. The data categories may include the players category and at least one category selected from the group of a benchmarks category, a functional information category, a rules-based category, a transparency category, and a consequence category. Preferably, each of the non-players databases has a plurality of data elements tables and each of the data elements tables has a player component key pointing to a player in the players database. The system may also have programming to identify a missing player component key from a data input. The system may also have a second classifier having a behavioral model for players. The second classifier is programmed to compare data having the same value for the player component key to the behavioral model for players to identify abnormal data. The second classifier may also be programmed to generate an analytic roadmap of the investigation case to aid in the investigation. The second classifier may have an expert system, machine learning, a decision tree, a neural network or combinations of the four.

The server programming to identify discoverable gaps may include an expert system or machine learning. The second classifier has the same expert system or machine learning that the server programming has.

The system may alert a user to a discoverable gap responsive to the identification of the existence of the discoverable gap.

The system may have a second classifier programmed to generate an analytic roadmap of the investigation case to aid in the investigation and programmed to identify abnormal data points in the pooled database.

The system may have a data source database accessible to the system and the data source database is selected from the group consisting of an activities of daily living flows database, an activities of daily workflows database, an industry data points data base, a revenue cycle data points database, an operational data points database, a product data points database, a service data points database, a prevention, detection, and mitigation workflows database, a player data points database, and combinations thereof.

In another embodiment of the invention, a system using artificial intelligence for investigating cases of fraud, waste, abuse and anomaly is provided. The system has a plurality of databases corresponding to a plurality of data categories of a framework of a fraud, waste, abuse or anomaly model. The databases containing data inputs from prior investigated cases. The system also has a pooled database of the case, a server programmed to identify discoverable gaps in the pooled database of the case, and a second classifier programmed to identify abnormal data points in the pooled database.

The data categories may include at least one category selected from the group consisting of a players category, a benchmarks category, a functional information category, a rules-based category, a transparency category, a consequence category and combinations thereof.

The system may have a data warehouse including the plurality of databases. The data warehouse has a fact table containing reference keys pointing to dimension tables in each of the databases. The data categories may include a players category and at least one category selected from the group consisting of a benchmarks category, a functional information category, a rules-based category, a transparency category, and a consequence category. Each of the non-players databases has a plurality of data elements tables and each of the data elements tables has a player component key pointing to a player in the players database.

The system may also have programming to identify a missing player component key from a data input. The second classifier may have a behavioral model for players. The second classifier is programmed to compare data having the same value for the player component key to the behavioral model for players to identify abnormal data. The second classifier may also be programmed to generate an analytic roadmap of the investigation case to aid in the investigation. The second classifier may have an expert system, machine learning, a decision tree, a neural network or combinations of the four.

The server programming to identify discoverable gaps may include an expert system or machine learning. The second classifier has the same expert system or machine learning that the server programming has.

The system may alert a user to a discoverable gap responsive to the identification of the existence of the discoverable gap.

The second classifier may also be programmed to generate an analytic roadmap of the investigation case to aid in the investigation.

The system may have a data source database accessible to the system and the data source database is selected from the group consisting of an activities of daily living flows database, an activities of daily workflows database, an industry data points data base, a revenue cycle data points database, an operational data points database, a product data points database, a service data points database, a prevention, detection, and mitigation workflows database, a player data points database, and combinations thereof.

The server may be configured to receive data inputs for an investigation case of fraud, waste or abuse. The system may have a data inputs classifier for classifying the data inputs into a plurality of data categories of the framework.

### BRIEF DESCRIPTION OF THE DRAWINGS

FIG. 1 is an illustration of a linear methodology designed to provide a comprehensive outcome determination driven by a of six critical behavioral components, consisting of the “Player Component,” “Benchmark Component,” “Functional Informational Component,” “Rules-Based Component,” “Transparency Component,” and “Consequence Component.”

FIG. 2 is an illustration of a skeletal decision tree structure designed to support the methodological process including data components, data drivers required for a comprehensive outcome determination driven by the six critical behavioral components: “Players Component,” “Benchmarks Component,” “Functional Information Component,” “Rules-Based Component,” “Transparency Component” and “Consequence Component.”

FIG. 3 is an illustration of data drivers or the mechanical data (fact(s), statistic(s), code(s), items of information and data) that create and fuel activity, collection, unification, analysis and/or computations resulting in a comprehensive, unified final output.

FIG. 4 is an illustration of a framework that incorporates the methodology, of FIG. 1, skeletal structure of FIG. 2, and data drivers of FIG. 3 to provide the mechanism for an output determination in order to identify, collect, authenticate, transform and/or unify fragmented data.

FIG. 5 depicts an analytic roadmap for an illustrative banking industry revenue cycle that may be investigated.

FIG. 6 is a schematic illustration of a system according to the invention.

FIG. 7 represents the data schema of databases used in the invention.

### DETAILED DESCRIPTION OF THE INVENTION

This invention, the FWAA-IIRB Model and Framework, establishes an analytical roadmap, a mechanism to mitigate inadequate, disconnected, un-unified, fragmented information while addressing personal bias and professional, political, psychosocial and socioeconomic conditions, allowing for a holistic “head-to-toe” approach to combating fraud, waste, abuse, and anomaly. The inventor has discovered that fraud, waste, abuse and anomaly (FWAA) varies across different industries because of industry-specific characteristics but every fraud, waste and abuse can be divided into behavioral components (or behavioral components) according to a behavioral model for FWAA. This insight informs the invention, which allows effective and dependable investigations of FWAA without having highly experienced investigators that are knowledgeable about the specific industry in which one or more perpetrators has found loopholes or vulnerabilities due typically to relevant data about the fraud, waste or abuse being fragmented.

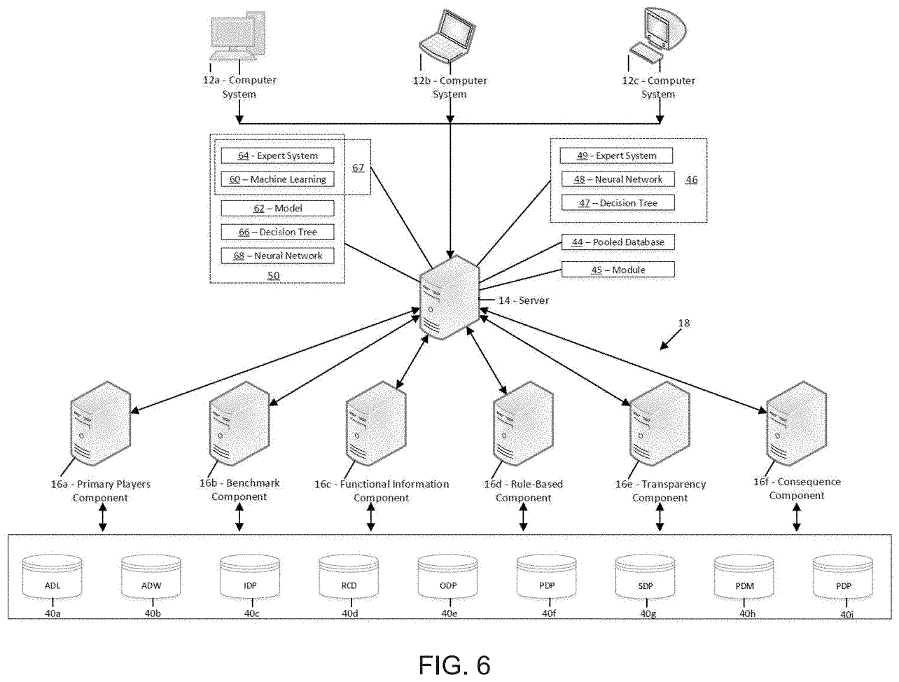

In one aspect of the invention, a system 10 for identifying fraud, waste, abuse and anomaly in an industry is provided. System 10 has one or more computer devices 12. Users of system 10 are usually located at a computer device 12. deployed in the industry and a server 14 communicatively linked to the plurality of industry computer devices 12, such as by the Internet or ethernet. Device 12 has a processor, typically a microprocessor, and computer memory. Server 14 has a processor, typically a microprocessor, and computer memory. As used herein, server as in server 14 can be a physical server or a cloud or virtual server. The industry can be any kind of industry. Industries featuring fragmented and disconnected data that often have loopholes and vulnerabilities including, for example, banking and financial services, government, manufacturing, healthcare, educational institutions, and retail sector. Server 14 is configured to receive data inputs pertaining to a discrete case from computer devices 12 and has programming to sort the data inputs into one or more applicable behavioral components 16a-16f of a framework 18 comprising behavioral components 16a-16f. As shown in FIG. 6, behavioral components 16 are illustrated as stand-along computers, but can be located on server 14. The behavioral components 16 include a Player Component 16a, a Benchmark Component 16b, a Functional Information Component 16c, a Rules-Based Component 16d, a Transparency/Opaqueness/Obstruction Component 16e, and a Consequence Component 16f. Player Component 16a refers to a person, place or thing and is the nucleus of the process; information collected for each player is cross referenced with each data input belonging to a different behavioral component 16b-16f. The player can be any market player including patients, providers, payers, vendors and any other third-party entity, associated with the case. A Benchmark Component 16b may be an attribute of a Player, such as that player's standard, point of reference, and/or measurement. A Benchmark may also refer to a standard, point of reference, or measurement within and/or among each other component within the behavioral continuum. Functional Information Component 16c refers to all relational knowledge derived by persons, communication systems, circumstances, research, processes, technology, and/or behaviors realized by each identified player, as well as within and/or among the other components within the behavioral continuum. A Rules-Based Component 16d may refer to any related rule, principle, or regulation governing conduct, actions, procedures, and arrangements, or to contracts, legislation, or dominion and control generated by each identified player, or existing within and/or among the other components of the behavioral continuum. Transparency/Opaqueness/Obstruction Component 16e refers to the degree of openness and accessibility, inaccessibility, or even resistance to access of information of or relating to players or other behavioral components 16. A Consequence Component 16f relates to a result, effect, importance, or significance of each player or their actions and/or of the other behavioral components 16.

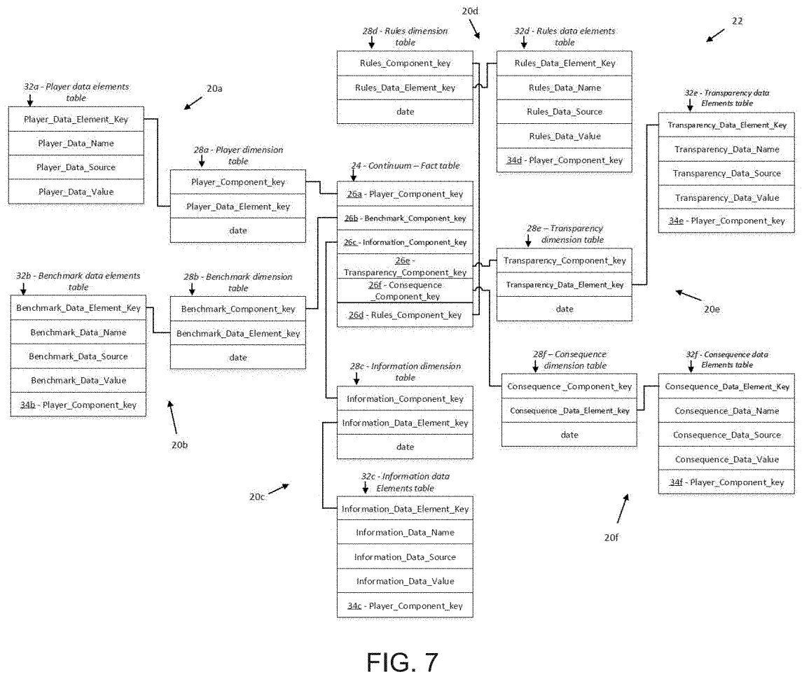

Each behavioral component 16 is communicatively linked to a plurality of databases 20 for storing data inputs. Databases 20 are illustrated in FIG. 7. Databases 20 are part of a data warehouse 22. Each behavioral component 16a-16f has a corresponding database 20a-20f. Data warehouse 22 and the individual databases 20 have a snowflake schema as shown in FIG. 7. Data warehouse 22 contains a fact table 24, which stores reference key values 26a-26f corresponding to each of six behavioral components 16a-16f for all cases investigated. Fact table 24 with reference key values 26 is linked to six dimension tables 28a-28f of databases 20a-20f, respectively, each corresponding to behavioral component 16a-161, respectively. Each dimension table 28 comprises keys 30 including a data element keys which link to data element dimension tables 32. Data dimension tables 32a-32f, which are part of databases 20a-20f, respectively, contain the sorted data inputs. Data dimension tables 32b-32f contain a player component key 34b-32f matches one of the player component keys 26a in fact table 24. By this matching, sorted data inputs are matched or related to specific players in an investigation case. It is well understood in a snowflake schema that the various keys 26 and 30 reference and connect the various tables 24, 28 and 32 together. Data element dimension tables 32 are conventional in a snowflake schema for storing the data inputs.

The relevant data inputs are typically obtained from data drivers 40 by system 10 and are analyzed by system 10. Data drivers 40 include a data driver 40a for activities of daily workflows (ADW), a data driver 40b for activities of daily living flows (ADL), a data driver 40c for industry data points (IDP)—such as the geographic scope, boundaries and dominant economic characteristics, a data driver 40d for revenue cycle data points (RCD), a data driver 40e for operational data points (ODP), which are qualifiable values expressing the business performance, a data driver 40f for product data points (PrDP), which are the physical or digital good, the attributes of existence, having a name, being trade-able, sold, utilized, a data driver 40g for service data points (SDP), which are the professional, non-professional, para professional service, the attributes or provision, having a name, tradeable, sold provided, a data driver for 40h for player data points (PIDP), which are the identification of each individual, party, organization, the attributes of existence, having a title, skill, role, and a data driver 40i for prevention, detection and mitigation (PDM) data points.

System 10 maintains a pooled database 44 of the case being investigated on server 14, typically separately from behavioral components 16 and databases 20.

Server 14 has a natural language processing module 45 for understanding textual data inputs from data drivers 40. Module 45 is an input into a data inputs classifier 46 for classifying the data inputs into the appropriate database 20. Classifier 46 is located on server 14. Preferably, classifier 46 uses decision trees 47, one or more neural networks 48 and an expert system 49 to perform the classification. In a preferred way of training the classifier, the classifier learns from user classification of data inputs in investigating an actual case of fraud, waste or abuse. Classifier 46 assigns the appropriate component key 26 to the data input which allows the data input to be sorted into the correct behavioral component 16 and database 20. Classifier 46 is used to repeatedly classify data inputs.

Server 14 has progressive and regressive algorithms. The progressive algorithms 51 sort the classified data inputs into the correct database 20 and build database 20. If the classified data input does not have a value to player component key 34 assigned to it, the regressive algorithms 67 will discover the lack of a value, which is a discoverable gap, and system 10 will prompt the user to enter the value of key 34.

Based on the data inputs in pooled database 44, regressive algorithms 67 may determine that there is “expected data” still to be input. Regressive algorithms 67 has artificial intelligence to recognize patterns of data in pooled database 44 that suggest data is missing or expected, i.e., that there is a discoverable gap. Such artificial intelligence includes expert system 64 and machine learning 60. System 10 will then prompt the user for the missing or expected data.

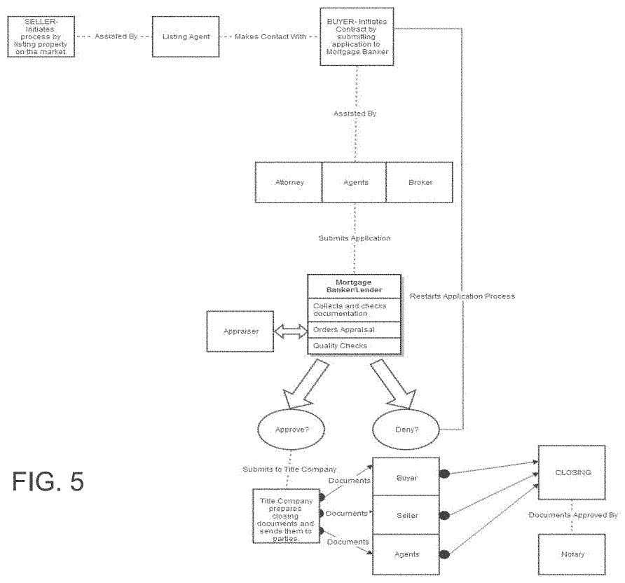

There are also regressive algorithms including a classifier 50 that operates on pooled database 44 of the case, a.k.a, pooled database classifier 50. Pooled database classifier 50 can be any suitable classifier including an expert system 64, machine learning 60, decision trees 66, neural networks 68 or combinations thereof. Preferably classifier 50 has expert system 64, machine learning 60, decision trees 66, and neural networks 68. Classifier 50 compares the data for a specific player, i.e., data having the same value for player component key 34, to a player behavioral model 62 for the player, and does so for each player. Based on the comparison, the data may be considered to be normal (consistent with the behavioral model) or abnormal (inconsistent with the behavioral model). The behavioral model is inherent in the classifier 50. The output of classifier 50 is an analytic roadmap or an identification of one or more abnormal data points, and sometimes both. Indeed, the identification of an abnormal data point by classifier 50 may be weighted more heavily in the generation of the analytic roadmap. Analytic roadmap may be passed to a suitable program, software module, graphics engine or visualizer 52 for graphically representing the analytic roadmap in an analytic roadmap output 54. FIG. 5 is a hypothetical example of an analytic roadmap output 54e. Analytic roadmap output 54 permits the user of system 10, e.g., a FWAA investigator, to further investigate the case by showing or suggesting the behavioral component values that the investigator should identify. Output 54 does not need to show all of the behavioral components values. For example output 54e, principally shows the players and activity daily workflow (ADW). An analytic roadmap may have more than one analytic roadmap outputs 54. In a preferred way of training classifier 50, classifier 50 learns from user classification of past pooled databases 44 from past FWAA investigations in which totality of data is achieved.

If an abnormal data point is not identified by classifier 50, the user further investigates the case using analytic roadmap output 54 as a guide for collecting further data inputs. These further data inputs are inputted into system 10 and are processed as described earlier, e.g., classified, sorted, pooled database 44 augmented and discoverable gaps identified in the augmented pooled database 44. The system can thus be considered to be iterative. Once totality of data is achieved (no discoverable gaps identified) and/or one or more abnormal data points are identified, a final output similar to output 54 is generated. The user can then make a final conclusion or report based on the final output.

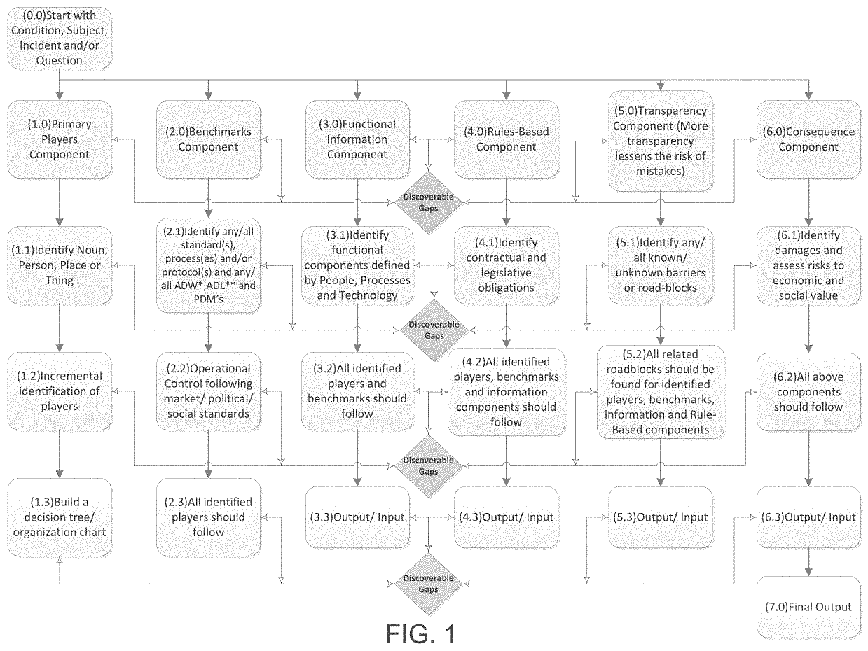

The functioning of system 10 is depicted schematically in FIGS. 1-4. Data, i.e., behaviors, are input into system 10. “Behaviors,” the behavioral data inputs, may refer to responses, actions, reactions, or functioning of parties or players within a system, or to those of the system itself, and may be subject to certain conditions or specific to certain industries or types of organized activity. The data inputs are classified by data input classifier 46. The user typically reviews the classifications and accepts or changes them. The acceptance or change is part of the learning aspect of classifier 46. The classified data inputs are then sorted into the behavioral components 16/databases 20 and in pooled database 44. Accurate sorting of the data inputs into behavioral components 16 drives the selection of the correct relational data driver for additional data inputs. For example, a particular industry or type of organized activity may have a characteristic or typical revenue cycle that defines parameters of an investigation and/or analysis performed in accordance with the invention. These additional data inputs are analyzed and processed by system 10 as described above.

The regressive algorithms are applied to the data (very likely fragmented and incomplete initially) within pooled database 44; the regressive algorithms may be running in the background, immediately prior to the sorting of a classified data input, or after the sorting. The regressive algorithms typically identify missing data initially and towards the conclusion of the investigation abnormal datum or data. Assuming missing data is identified, system 10 prompts the user to provide the missing data or “discoverable gap.” If the user provides the missing data in response to the prompt, the resulting data input is classified, sorted into databases 20 added to pooled database 44, and regressive algorithms rerun. System 10 continues to iterate until the regressive algorithms finds abnormal data and then system 10 will report the abnormal data to the user.

If the regressive algorithms do not identify any missing data and no abnormal data points, classifier 50 will generate an analytic roadmap which can be used by the user to further investigate the case. This further investigation will likely result in additional data inputs to system 10 being made and system 10 repeating its analysis.

Once totality of data is achieved (no discoverable gaps identified) and/or one or more abnormal data points are identified, a final output similar to output 54 is generated. The final output may include a detection analytic roadmap output, which is useful for detecting that there was FWAA, a concealed mitigation analytic roadmap output, which is useful for identifying corrective measures for fighting future FWAA, a severity assessment analytic roadmap output, which is useful for determining how much damage was created by a specific case or related cases of FWAA, or combinations thereof. The user can then do an informed analysis based on the final output and then make a final conclusion or report.

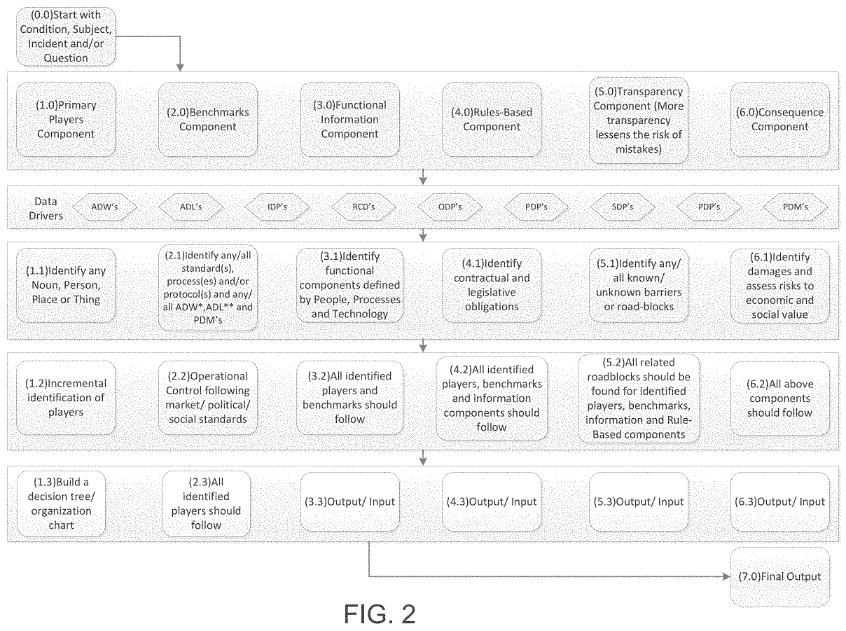

FIG. 2 illustrates a system of interactive and iterative behavioral computational processes within and among each behavioral component. Incremental and interactive information is added to the system within each component.

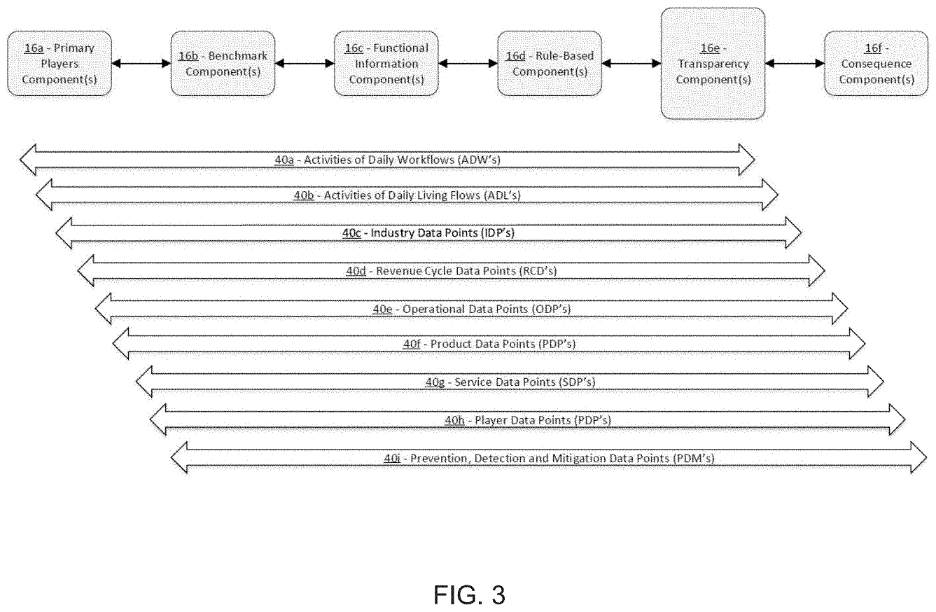

With reference to FIG. 3, the defined data drivers may be used to resolve identified data gaps.

### Example: Identity Theft—Sample Components from One Issue in a Case

In the following simplified hypothetical example which shows how the system is used to investigate a real world fraud, the actions described as being performed by a “computer system” are performed by a computer processor executing instructions stored on a computer readable storage medium. An example of the simplification is that irrelevant data inputs are not discussed although it isn't known at the start of an investigation what is or is not relevant. The user of the system as described in the example is a FWAA investigator. In the example, the computer system is able to accept data from various data drivers and other sources including scanned documents. The example relates to a fraud victim, a female spouse in the process of getting divorced, who attempts to open up a checking account to deposit cash. The bank refused to open an account. The victim runs a credit report with a reported score of 358:

FWAA-IIRB Model, Framework, and Analytic Roadmap
Computer system provides and user validates, the selection and/or creates relevant industry revenue cycle component(s) within the specified industry (FIG. 5 is based in part on a Mortgage Banking Revenue Cycle model)

Initiate Model of FIG. 1:
Computer system input of Players (optionally inputs classified by a data inputs classifier and the classifications and data inputs are validated by user, inputs sorted and added to pooled database: Bank refusing checking account; Female Spouse; Male Spouse; homestead residence; residence Mortgage Company.
   Computer system input of Benchmarks (optionally inputs classified by a data inputs classifier and classifications validated by user), inputs sorted and added to pooled database—the system processes incremental data elements that are updated for continuous, contemporaneous progressive analysis leading to the final output. The following describes some of the data inputted
      Bank refuses to create bank account for spouse (a bank subject to rules established by the Office of the Comptroller of the Currency (OCC) which are added to the rules-based component.
      Female Spouse (homemaker, no independent credit cards or checking account, signer on loan)
      Homestead residence (purchased by both spouses for $600,000, the current bank note documented on the house was $1.7 million)
      Resident Mortgage Company (central bank) and feeds aggregated data pool of case
      Mortgage equity loan exceed market value by $1 million.

Integrate Framework of FIG. 2:
Computer system input of Transparency components (optionally inputs classified by a data inputs classifier, and inputs and classifications validated by user) inputs sorted and added to pooled database: Victim did not recognize her signature on the mortgage document—source of signature not known. Computer system conducts a human capital analysis using the progressive and regressive algorithms stored. Human capital analysis allows the system to collect data for a specific player and attributes associated with the player. This analysis is used to evaluate the skills, knowledge, and experience possessed by each of the respective players and feeds the aggregated data pool of the case.
Discoverable Gap is identified by system: As a result investigator locates copies of mortgage documents that are analyzed by the system which detects a false signature of female spouse through the use of a regressive algorithm. Computer system output of an abnormal data point is validated by user.
   Player identified: Notary of mortgage documents. User validates classification.
   Benchmark: Notary Association Professional Standards (The Notary Public Code of Professional Responsibility and conduct). User validates classification.
   Rule: Notary Deal requirements of Ill. Comp. Statutory Section legislative code. § 3-101 User validates classification.
   Functional information component: notary was a high school friend of both spouses; did not witness victim sign mortgage. User validates classification.

Integrate Data Drivers of FIG. 3:
Abnormal Data Point identified: Notary did not witness signature of victim. Computer system output is validated by user. Additional inputs:
   Player: input of data relating to male spouse, who is now suspected of perpetrating fraud, including a lack of recent employment. User validates inputs and classification.
   Consequence: Victim was represented as a financial guarantor by the unauthorized use of her signature in a series of home equity lines. The user validates inputs and classification.
   Functional information: found 5 supplemental equity lines. User validates classification.
   All transactions involved same broker and real estate appraiser. User validates findings.
   Player: broker & appraiser added as players. User validates classification.
   Benchmark: broker & appraiser (department of professional regulation). User validates classification.
Discoverable gap is identified: Investigator conducts further investigation and finds that value of home could not be substantiated, male spouse deposited equity line loans into a separate account unknown by the victim, and male spouse had exhausted his own credit—then utilized spouse for ongoing credit. Computer system input and classifications are validated by user.
Consequence: Victim credit score damaged from unknown loans and unauthorized use of identity by perpetrator. User validates classification.

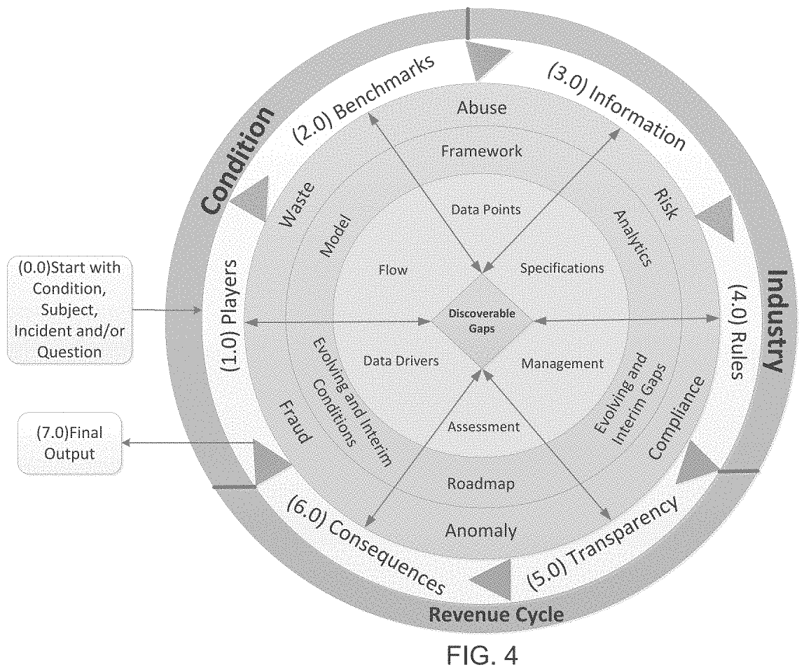

FIG. 4 and Final Output:
Computer system input of Interactive, Iterative, Reiterating Analytic Model and Framework integration of data points and validated by user. The outer ring in FIG. 4 is the underlying supporting structure for a specific framework. FIG. 5 illustrates an analytic roadmap based on the data inputs and the nature of the case being investigated. The subsequent relevant components are identified (1.-6.0) Following by the analytic applications of Fraud, Waste, Abuse, Risk, compliance, anomaly (the system learns by recognizing new attributes, stores in the appropriate data driver, by applying progressive and regressive algorithms iteratively. The final output is a summary of the data inputs and the abnormal data points:
   Players: Bank refusing checking account; Female Spouse; Male Spouse; homestead residence; residence Mortgage Company; Notary of mortgage documents; broker & appraiser
   Benchmarks (player is listed followed by the benchmark): Bank refusing checking account (OCC as governing authority); Female Spouse (homemaker, no independent credit cards or checking account, signer on loan); Homestead residence (purchased by both spouses for $600,000, current note on house $1.7 million); Resident Mortgage company (OCC); Notary (The Notary Public Code of Professional Responsibility); broker & appraiser (department of professional regulation). User validates findings.
   Functional information component: notary did not witness victim signature, notary is high school friend of both spouses; 5 supplemental equity lines; All transactions involved same broker and real estate appraiser.
   Rule: Notary Deal requirements of III. Comp. Stat. § 3-101; Central Banking Rules. User validates findings.
   Transparency: Victim did not recognize her signature on the mortgage document—source of signature not known. User validates findings.
   Consequence: Victim was represented as financial guarantor for an unknown series of equity lines; victim credit score damaged from unknown loans and unauthorized use of identity by perpetrator.
Abnormal Data Points:
   copies of mortgage documents produced have a false signature of female spouse; computer system output is validated by user.
      Notary did not witness signature of victim; computer system output is validated by user.
      value of home could not be substantiated; perpetrator deposited equity line loans into a separate account unknown by the victim. Perpetrator exhausted his own credit—then utilized spouse for ongoing credit. Computer system output is validated by user.
   Based on the output, the investigator concludes that male spouse colluded with broker and real estate appraiser to strip homestead equity in excess of $1.2 million dollars; upon exhaustion of personal credit utilized a familiar notary as the mechanism of theft (victim identity) on mortgage documents to continue mortgage equity stripping scheme.

This invention is unique in that it provides an interactive and iterative system and methodology to complete the required data collection from fragmented data source point, comprehensively identifying, assessing, and analyzing gaps ensuring sufficiency of data leading towards an outcome determination. The invention avoids fragmented and compromised outcome determinations. In each iteration of data inputs, progressive algorithms appropriately classifies the inputs into certain databases based on a FWAA behavioral model and regressive algorithms identify data gaps, abnormal data points and analytic roadmaps resulting in a highly stable fraud, waste abuse and anomaly detection tool. The invention accommodates data input in linear (FIG. 1) and non-sequential orders (FIG. 2).

The FWAA-IIRB Model and Framework of the present invention is unique because it is not a one-size fits all approach. For example—a banking mortgage loan fraud by a buyer is totally different from an insurance claim fraud by a provider. The invention automatically provides an analytic roadmap based on the data inputs to assist a FWAA investigator. In addition to the above, the invention is comprehensive in data collection and effective in handling a wide variety of situations, players and industries. The invention builds data volume by discovering data gaps as the system/method proceeds to final output/results.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A system using artificial intelligence for investigating cases of fraud, waste, abuse and anomaly, the system comprising:
a server configured to receive data inputs for an investigation case of fraud, waste or abuse;
a data inputs classifier for classifying the data inputs into a plurality of data categories of a framework of a fraud, waste, abuse or anomaly model;
a plurality of databases corresponding to the data categories of the framework, the server programmed to sort the classified data inputs into the databases by data category and into a pooled database of the case; and
server programming to identify discoverable gaps in the pooled database of the case.

2. The system of claim 1 wherein the data inputs classifier comprises artificial intelligence selected from the group consisting of a decision tree, a neural network, an expert system and combinations thereof.

3. The system of claim 1, wherein the data categories comprises at least one category selected from the group consisting of a players category, a benchmarks category, a functional information category, a rules-based category, a transparency category, a consequence category and combinations thereof.

4. The system of claim 1 further comprising a data warehouse comprising the plurality of databases, the data warehouse comprising a fact table containing reference keys pointing to dimension tables in each of the databases.

5. The system of claim 4 wherein the data categories comprises a players category and at least one category selected from the group consisting of a benchmarks category, a functional information category, a rules-based category, a transparency category, and a consequence category.

6. The system of claim 5 wherein each of the non-players databases comprises a plurality of data elements tables and each of the data elements tables has a player component key pointing to a player in the players database.

7. The system of claim 6 further comprising programming to identify a missing player component key from a data input.

8. The system of claim 6 further comprising a second classifier, the second classifier comprising a behavioral model for players, the second classifier programmed to compare data having the same value for player component key to the behavioral model for players to identify abnormal data.

9. The system of claim 8 wherein the second classifier is further programmed to generate an analytic roadmap of the investigation case to aid in the investigation.

10. The system of claim 8 wherein the second classifier comprises an expert system, machine learning, a decision tree, a neural network or combinations thereof.

11. The system of claim 1 wherein the server programming to identify discoverable gaps comprises an expert system or machine learning.

12. The system of claim 11 wherein the second classifier comprises the expert system or machine learning that the server programming has.

13. The system of claim 1, wherein the system alerts a user to a discoverable gap responsive to its identification.

14. The system of claim 1 further comprising a second classifier programmed to generate an analytic roadmap of the investigation case to aid in the investigation and programmed to identify abnormal data points in the pooled database.

15. The system of claim 1, further comprising a data source database accessible to the system, the data source database selected from the group consisting of an activities of daily living flows database, an activities of daily workflows database, an industry data points data base, a revenue cycle data points database, an operational data points database, a product data points database, a service data points database; a prevention, detection, and mitigation workflows database, a player data points database, and combinations thereof.

16. A system using artificial intelligence for investigating cases of fraud, waste, abuse and anomaly, the system comprising:
a plurality of databases corresponding to a plurality of data categories of a framework of a fraud, waste, abuse or anomaly model; the databases containing data inputs from prior investigated cases;
a pooled database of the case;
a server programmed to identify discoverable gaps in the pooled database of the case; and
a second classifier programmed to identify abnormal data points in the pooled database.

17. The system of claim 16, wherein the data categories comprises at least one category selected from the group consisting of a players category, a benchmarks category, a functional information category, a rules-based category, a transparency category, a consequence category and combinations thereof.

18. The system of claim 16 further comprising a data warehouse comprising the plurality of databases, the data warehouse comprising a fact table containing reference keys pointing to dimension tables in each of the databases.

19. The system of claim 18 wherein the data categories comprises a players category and at least one category selected from the group consisting of a benchmarks category, a functional information category, a rules-based category, a transparency category, and a consequence category.

20. The system of claim 19 wherein each of the non-players databases comprises a plurality of data elements tables and each of the data elements tables has a player component key pointing to a player in the players database.
